(19) United States
(12) Patent Application Publication
(10) Pub. No.: US 2011/0096909 A1
(43) Pub. Date: Apr. 28, 2011

(54) MOUNT FOR ROTATING TARGET

(76) Inventors: Catherine Le-Guet, La Motte-Servolex (FR); Nicolas Chapel, Annecy (FR); Cindy Rude, Annecy-le-Vieux (FR)

(21) Appl. No.: 12/737,088

(22) PCT Filed: Apr. 30, 2009
(86) PCT No.: PCT/FR2009/050805

§ 371 Date: Dec. 7, 2010

(30) Foreign Application Priority Data
Jun. 27, 2008 (FR) 0854325

(51) Int. Cl. H01J 35/10; H05G 1/02

(52) U.S. Cl. 378/144; 378/197

(57) ABSTRACT

The object of the present invention is a mount for a rotating target, roughly disk-shaped and perforated at its center. The mount is made of a material which a structurally hardened nickel-based superalloy. The mount is disk-shaped with a narrower area at its periphery, and the narrow peripheral area and the thick area surrounding the central orifice are separated by a discontinuous area whose slope is between 3° and 10°, with the thickness ratio between the narrow peripheral area and the thick area surrounding the central orifice being between 1.5 and 3. The superalloy is an Inconel that has undergone a structural hardening treatment after machining. At least one of the mount's surfaces is coated with an emissive coating used to discharge heat through thermal radiation.

The present invention pertains to a mount for a rotating target, such as a rotating anode used to generate a beam of X-rays. These anodes are particularly used in very high brightness sources of X-rays.

A source of X-ray radiation normally comprises a vacuum chamber bounded by an airtight wall, wherein a cathode designed to generate a flow of electrons is disposed. Inside the vacuum chamber, there is also a rotating anode, which is caused to rotate around a rotational axis, and which on its periphery receives the flow of electrons emanating from the cathode, and thereby emits X-rays which are directed towards an output.

Such a device is described, for example, in document EP 1,804,271, in which the rotating anode is installed on the same shaft as the turbomolecular vacuum pump.

The X-rays are generated during the interaction of an electron beam with a target. A small portion of the electrons' energy is converted into X-rays, with the majority being absorbed by the target's material and transferred to its mount. For a very bright source, the beam's energy and the energy density at the electron spot are very high. It is therefore necessary to rotate the target at a very high rotational velocity (typically above 25,000 rpm) in order to reduce exposure time and limit the increase of temperature at the electron spot's impact zone, and thereby to prevent the fusion or sublimation of the material forming the target. Mechanical stresses resulting from the rotational velocity and heat gradient are therefore high (greater than 400 MPa), as is the energy intake (generally greater than 200 W) and the mean temperature of the target's mount (often greater than 300° C.).

The anodes used in the sources of X-rays include the target and its mount, which is normally made of copper or graphite. However, these materials cannot withstand the mechanical stresses caused by operation at a high rotational velocity and a high temperature, which causes the mount to creep, meaning that the metal part subjected to a constant stress gradually and irreversibly warps. The creep speed increases when the material's temperature increases. In order to give the device a sufficient lifespan, the creep of the mount and rotating target must remain below the rupture limit of the mount's material. Additionally, the mount must be electrically conductive enough to enable the transfer of electrical loads (greater than 5 mA, 50 keV) to discharge the electrons which bombard the rotating target.

A multi-step method to manufacture a dispersion-hardened alloy has been proposed in order to combat thermal creep. The method described makes it to possible to give the alloy the sought-after mechanical properties. This alloy may particularly be used to construct rotating anodes for sources of X-rays. This method is complex, and involves a large number of successive steps, alternating various recasting processes at temperatures which, for at least part of the annealing treatment, are below the alloy's recrystallization temperatures.

However, the use of such a material is not sufficient to solve the problem of creep in rotating anodes.

In order to improve the usage performance of the source of very bright X-rays, it is desirable to apply the electron beam onto the target continuously, unlike conventional devices in which the beam is applied in pulses. The temperature that the target's mount must withstand will therefore be substantially higher than in the devices of the prior art, and creep would increase accordingly.

The purpose of the present invention is to propose a mount for a rotating target whose creep characteristics are adapted to the operating conditions of a device for emitting a very bright X-ray.

The object of the present invention is a mount for a rotating target, roughly disk-shaped and perforated at its center. According to the invention, the mount is made of a material which is a nickel-based structurally hardened superalloy, and additionally has the shape of a disk with a narrower area on its periphery, with the narrow peripheral area and the thick area surrounding the central orifice being separated by a discontinuous area whose slope is between 3 et 10°, and wherein the ratio of the thickness of the narrow peripheral area and that of the thick area surrounding the central orifice is between 1.5 and 3.

For example, the slope of the discontinuous area may be about 4.6°, and the ratio of the thickness of the narrow peripheral area and that of the thick area surrounding the central orifice may be about 1.7.

The shape of the support is also optimized so as to limit the mass being rotated, which limits the drive energy. As a result, the rotating anode may be installed on the shaft of a conventional turbomolecular pump, without needing to modify the pump's design. By minimizing mechanical stresses during the rotation of the anode, this narrower shape makes it possible to improve the rotating anode's stability and allow for a reduction in the rotor's height, and therefore increase the compactness of the overall system.

The mount has several millimeters of increased thickness around its central orifice compared to the mean thickness in the vicinity of the disk's is periphery. Preferentially, the mean thickness of the mount in the narrow peripheral area is less than 10 mm.

In one embodiment, the ratio between the outer diameter of the thick area surrounding the central orifice and the inner diameter of the perforated disk is between 1.2 and 2 inclusive, and may for example be about 1.4.

The mount has a middle area between the narrow peripheral area and the thick area surrounding the central orifice. In this area, hereafter known as the discontinuous area, the disk's thickness moves from the thickness value in the thick area to the thickness value in the narrow peripheral area, at a specific slope. Preferentially, the outer diameter of the discontinuous area is no greater than 90 mm.

The mount's inner diameter is affected by the means for attaching the rotating anode onto the rotor shaft. The mount's outer diameter is chosen so as to take into account the linear velocity at the electron spot, the level of mechanical stresses imposed by its rotating speed and its operating temperature, and the release of heat through radiation. In another embodiment of the invention, the mount's outer diameter is chosen such that the D/d ratio between the perforated disk's outer diameter D and its inner diameter d is between 2.5 and 5, for example, about 3.3.

The mount's inner diameter is preferentially between 40 and 80 mm, for example about 50 mm. The mount's outer diameter is preferentially less than 200 mm, for example about 150 mm.

Preferentially, the medium's material is a material known by the brand name “INCONEL®”, a superalloy primarily made of nickel (Ni), but also several other metals, particularly chromium (Cr), magnesium (Mg), iron (Fe), and titanium (Ti).

The initial machining of the anode is carried out on the solution-annealed material, i.e. an alloy that has undergone a heat treatment whose purpose is to place it into a solution of certain alloy components (phases, precipitates) and hold it there. The machined part is then subjected to an annealing treatment also known as aging. Annealing is done after a mechanical treatment, in order to make the material more homogeneous and increase its hardness. The part is heated until it is fully austenitized, then it is allowed to cool slowly, which restores its former properties. This treatment also makes it possible to relieve the stresses induced by the material's initial machining. However, as this hardening treatment causes the parts to shrink, it is necessary to machine them again after aging.

The purpose of this so-called “structural hardening” treatment is to create precipitates in the matrix. When the anode operates, these precipitates will impede dislocation movements and therefore prevent the warping of the anode due to creep.

In one embodiment, the target is made up of a copper- (Cu), molybdenum- (Mo) and/or tungsten- (W) based coating, deposited onto the peripheral edge of at least one surface of the mount. Preferentially, the coating is deposited onto the edge of both of the mount's surfaces. The coating is not necessarily the same on both surfaces. As the target and its support are reversible, several combinations of targets are possible: Cu—Cu, Cu—Mo, Mo—W, etc.

In one embodiment variant, at least one surface of the mount is coated with an emissive coating (blackbody), made of aluminate titanate for example, which serves to discharge heat through thermal radiation. The coating preferentially covers the entire available surface area, in order to maximize the heat exchange.

A further object of the invention is a rotating anode comprising a target borne by a mount, which is a roughly disk-shaped and is perforated at its center, made of a material which is a structurally hardened nickel-based superalloy, with a narrower area on its periphery, wherein the narrow peripheral area and the thick area surrounding the central orifice are separated by a discontinuous area whose slope is between 3 et 10° inclusive, and wherein the ratio of the thickness of the narrow peripheral area and that of the thick area surrounding the central orifice is between 1.5 and 3 inclusive.

The combination of an appropriate material, the use of an emissive coating, and an optimized shape gives the inventive mount numerous advantages. In particular, this invention has the advantage of offering a compact solution for generating a beam of very bright X-rays. In particular, for microelectronics measurement machines, the ability to continuously apply the electron beam not only makes it possible to improve the machine's performance by a factor of 5, but also to conduct direct analyses on integrated circuit production boards, using a beam with small dimensions (30 μm×30 μm).

Other characteristics and advantages of the present invention will become apparent upon reading the following description of one embodiment, which is naturally given by way of a non-limiting example, and in the attached drawing, in which:

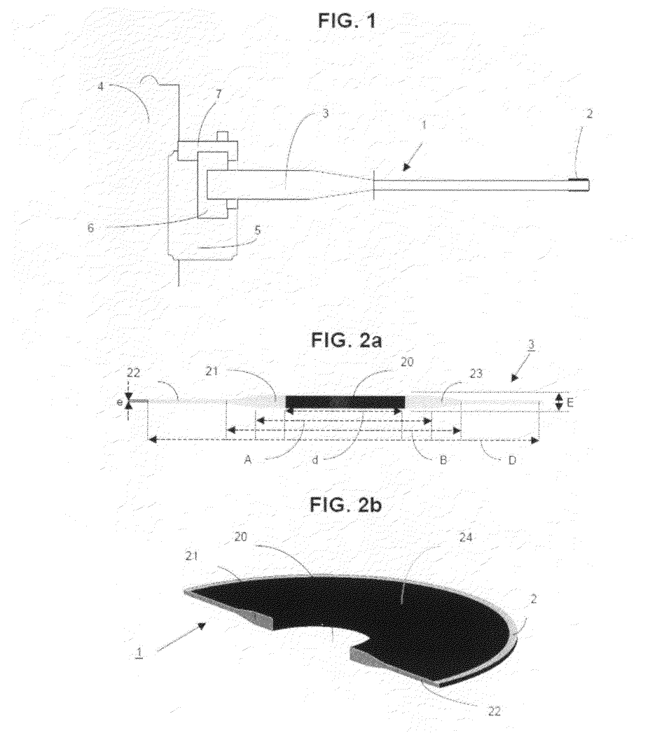

FIG. 1 represents a rotating anode, comprising a mount bearing a rotating target, connected to a rotation shaft according to one embodiment of the invention,

FIG. 2a is a cross-sectional view of the mount in FIG. 1,

FIG. 2b is a perspective view of the rotating anode in FIG. 1.

In the embodiment of the invention depicted in FIG. 1, the source of X-ray radiation comprises a vacuum chamber, wherein a rotating anode 1 is disposed, comprising at its periphery a target 2 that receives the flow of electrons from a cathode, also placed in the chamber, and that emits X-rays which are guided to an output. The target 2 is borne by a mount 3 with a particular profile shape. This shape is a narrow disk having an orifice at its center to allow the rotation axle through. In the present situation, the rotating anode 1 is driven to rotate by the shaft 4 of the rotor of the turbomolecular pump to which it is connected. The rotating anode 1 is connected to the shaft 4 by a fastening part 5, is from which it is separated by a heat-insulated part 6. The assembly is fastened by means of a tightening part 7.

We shall now consider FIG. 2a, which depicts the rotating mount 3 in a cross-sectional view.

The mount 3 is a disk bearing a circular orifice 20 at its center. The inner diameter d of the mount may, for example, be 45 mm, and its outer diameter D may, for example, be 148 mm, for a D/d ratio of 3.23.

The mount 3 has a thicker area 21 near the central orifice, for example one having a thickness E of 5 mm. This area 21 has a diameter A which may, for example, be 65 mm, for an A/d ratio of 1.44 in this situation. At its periphery, the mount includes a narrower area 22, for example one having a thickness e of 2 mm.

Between the thicker area 21 and the narrower area 22 is a transitional area 23 which has a discontinuous thickness between its inner diameter A and its outer diameter B. The inner diameter A may, for example, be 65 mm and the outer diameter B may, for example be 90 mm, a slope of 6.8° for the discontinuity shown.

Naturally, depending on the embodiment, the areas described above may also be divided into sub-areas having slightly different dimensional characteristics, while remaining within the scope of the present invention.

The mount 3 is made up of a nickel-based superalloy, preferentially Inconel, which has suitable creep limits for the rotating anode's working conditions.

FIG. 2b shows the rotating anode 1 in perspective view. The energy applied to the target is above 200 Watts, and the energy that reaches the rotating shaft must be less than 50 Watts, so as, not to heat the pump's turbine (maximum 130° C.). This difference in energy must therefore be discharged before reaching the shaft. A coating 24 made of aluminate titanate applied on all sides of the mount 3, on each of its faces, is what enables cooling through radiation and an improved power discharge. This black-colored coating 24 covers the surface from the central orifice 20 of the mount 3 all the way up to a distance more than 3 mm away from the outer edge of the mount 3.

The target 2 which generates the X-rays is a thickly applied coating deposited on the outer edge of the mount 3. The main component of the coating may, for example, be copper Cu, molybdenum Mo and/or tungsten W. The target 2 and its mount 3 are designed to be reversible. The application of the target's 2 coating is preferentially on both surfaces of the mount 3. Different combinations may therefore be considered in the nature of the coating forming the target 2. Furthermore, so as not to increase the dimensions of the X-ray beam, the target 2 is polished, and its flatness is ensured at the micron level prior to installing the rotating anode 1 onto the shaft 4 of the pump.

1. A mount for a rotating target, roughly disk-shaped and perforated at its center, wherein the mount is made of a material which is a structurally hardened nickel-based superalloy, and wherein the mount has the shape of a disk with a narrower area at its periphery, and wherein the narrow peripheral area and a thick area surrounding the central orifice are separated by a discontinuous area whose slope is between 3° and 10°, and wherein a thickness ratio between the narrow peripheral area and the thick area surrounding the central orifice is between 1.5 and 3.

2. The mount according to claim 1, wherein a mean thickness within the narrow peripheral area is less than 10 mm.

3. The mount according to claim 1, wherein an A/d ratio between an outer diameter A of the thick area surrounding the central orifice and an inner diameter d of the perforated disk is between 1.2 and 2.

4. The mount according to claim 1, wherein the discontinuous area's outer diameter B is no greater than 90 mm.

5. The mount according to claim 1, wherein a D/d ratio between the perforated disk's outer diameter D and its inner diameter d is between 2.5 and 5.

6. The mount according to claim 3, wherein the outer diameter D is less than 200 mm.

7. The mount according to claim 3, wherein the inner diameter d is between 40 mm and 80 mm.

8. The mount according to claim 1, wherein the superalloy is an Inconel that has undergone a structural hardening treatment after machining.

9. The mount according to claim 1, wherein at least one of its surfaces is coated with an emissive coating used to discharge heat through thermal radiation.

10. A rotating anode including a target borne by a mount that roughly disk-shaped and perforated at its centre, wherein the mount is made of a material which is a structurally hardened nickel-based superalloy, and wherein the mount has a narrower area at its periphery, and wherein the narrow peripheral area and a thick area surrounding a central orifice are separated by a discontinuous area whose slope is between 3° and 10°, and wherein a thickness ratio between the narrow peripheral area and the thick area surrounding the central orifice is between 1.5 and 3.
